(19) United States
(12) Patent Application Publication
(10) Pub. No.: US 2003/0149576 A1
(43) Pub. Date: Aug. 7, 2003

(54) Personalized smart room

(76) Inventor: Steven L. Sunyich, Santa Clara, UT (US)

Correspondence Address: Steve M. Perry, THORPE, NORTH & WESTERN, L.L.P., P.O. Box 1219, Sandy, UT, 84091-1219, US

(21) Appl. No.: 10/126,486

(22) Filed: Apr. 19, 2002

Related U.S. Application Data
(60) Provisional application No. 60/285,042, filed on Apr. 19, 2001.

(51) Int. Cl. G06F 17/60

(52) U.S. Cl. 705/1; 705/5

(57) ABSTRACT

A device and method for automatic hotel room check-in and pre-conditioning of hotel rooms. This device provides hotels or similar lodging facilities with the capability of personalizing a guest's room at check-in time. A guest card may be scanned at the time of check-in, with or without any interaction from a person at the hotel or lodging facility. After the guest is identified, a networked software application checks the guest into the hotel, personalizes the room, and electronically enables the guest to enter the room. The invention results in a number of personalized events happening without any interaction with the hotel personnel. A preferences database allows the hotel guest to customize room options based on reservation and environmental preferences.

This application claims priority to US Provisional Application No. 60/285,042 filed on Apr. 19, 2001.

### TECHNICAL FIELD

The present invention relates generally to automated hotel check-in and providing electronically customizable hotel rooms for hotel guests. More particularly, the present invention relates to a system and method for check-in and electronically setting the preferences for a hotel room.

### BACKGROUND ART

With the steadily increasing interest and need for personal and commercial travel, hotels and their service people must deal with the rigors of increased competition. Customer satisfaction remains the keystone of success in the lodging industry. When hotels are successful and please their guests, those guests return and make the hotel more profitable. In order to meet this challenge, hotels have added amenities such as pools, exercise rooms, in-room coffee, in-room minibars, etc. Unfortunately, these amenities and similar comforts are provided with the mentality of “one size fits all.” Indeed, it has been perceived as impractical to customize conveniences and services to an individual guest for their specific stay.

Limited customization, such as requests for a queen or king size bed or a nonsmoking versus smoking room, can be arranged through a reservation process and are usually booked in advance or by discussing it with a front desk clerk. Making a request for a king size bed or nonsmoking room requires the hotel clerk to check the current availability of the personal requests of the person checking in. Sometimes this information is kept in databases for one specific hotel chain, such as the Hilton Honors program, but the information stored is generally limited to room specifications such as the bed size, and smoking or nonsmoking categories. Otherwise, hotels maintain standard rooms, based on room size. Even if a hotel tracks a hotel guest's reservation preferences, this information is only stored for several months and it is not available at other hotels.

In addition to basic reservation requests, the hotel guest may want other more personalized requests. The common method for obtaining any special, personalized request is by having the guest request it from the clerk at reservation time or check-in. If the guest has a special request, it may require a few hours for the concierge or clerk to complete or retrieve that request.

Such procedures and delays have been generally accepted by the traveling community as a necessary limitation of a system which must deal with guests having different lifestyles, cultural backgrounds and personal preferences. The adjustment of the in-room environment is generally accomplished by the occupant, who personally sets the temperature, thermostat controls, and lighting when they use the room.

### SUMMARY OF THE INVENTION

The invention provides a method for automatically and electronically personalizing and pre-conditioning a hotel room for a hotel guest. The method includes the first step of storing the hotel guest's environmental preferences in a database prior to a hotel visit. The environmental preferences are later retrieved for a hotel guest who will be using the room. The final step is applying the environmental preferences to the hotel room in preparation for a guest's arrival.

In accordance with another aspect of the present invention, the system includes a device for automated hotel room check-in and hotel room preference setting. An electronic interface allows the hotel guest's preference information to be entered prior to a hotel visit. A database stores the hotel guest's environmental preference information which were entered into the electronic interface. In addition, an identification unit is configured to scan a guest identification card and initiate the retrieval of the hotel guest's reservation and environmental preferences from the database. An electronic network is configured to prepare the hotel room as specified by the environmental preferences.

Additional features and advantages of the invention will be set forth in the detailed description which follows, taken in conjunction with the accompanying drawings, which together illustrate by way of example, the features of the invention.

### BRIEF DESCRIPTION OF THE DRAWINGS

FIG. 1 is a block diagram of one embodiment of a system for automated hotel room check-in and electronic preference activation;

FIG. 2 is a flow chart of the steps taken during automated hotel room check-in and electronic hotel room preference activation;

FIG. 3 is a flow chart of the steps for applying environmental preferences to a hotel room.

### DETAILED DESCRIPTION

For the purposes of promoting an understanding of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

This is a device and method for personalizing hotel rooms and providing lodging facilities or hotel guests with the capability of personalizing and preconditioning the living conditions within the hotel guest's room. In the past, hotels have had limited automated check-in systems and the guest has generally been required to check-in by interacting with a clerk. Furthermore, prior art hotel systems lacked an effective system for electronically customizing and pre-conditioning a hotel room based on a hotel guest's preferences.

When a prospective hotel guest makes a hotel reservation, they can request their preferences for a queen or king size bed or a nonsmoking versus smoking room. In addition, a hotel guest may request a specific floor, a room location, room orientation, and room view. These types of preferences are generally defined as reservation preferences. This is because reservation preferences are related to the attributes of a room that are fixed. Other reservation preferences are items such as the existence of air conditioning, the existence of audible alarms, access to connecting rooms, kitchenettes, refrigerators, etc. These items are specific to a physical room and cannot readily be changed. A hotel guest requests these reservation preferences and the hotel finds a room which matches as many of the hotel guest's criteria as possible.

This invention allows a hotel guest to control an additional category of preferences which are defined as environmental preferences (e.g., temperature control). These are options that can be set in the hotel room remotely before the guest arrives at the hotel or enters the room. Options which are remotely configurable are things such as the room temperature, light settings, and window covering positions. A subcategory of the environmental preferences is the category of data preferences. These preferences control the data flow which may be enabled for that room. The data preferences are conditions implemented by the electronic systems and controls which enable cable channel selection, whether or not premium or adult movies can be viewed, whether the Internet connection is activated, which language will be available on the television, etc.

Another subcategory of environmental preferences is product preferences. These are preferences that affect product delivery. If a minibar or vending machine is available in the room, the hotel guest can request the products in advance that they want in the minibar. They can also control the language in which the minibar interacts with them. Another element that can be controlled as a product preference is the type of coffee that will be provided to a hotel guest. For example, different types of coffee may be provided in a network enabled electronic device or in the minibar. In addition, a hotel guest can also select which newspaper will be delivered to their room.

In one embodiment of the present system, the invention is implemented using a system to scan the guest's card at the time of check-in, with or without any interaction with a person at the hotel or lodging facility. After the card is scanned, the networked check-in software checks the guest into the hotel, personalizes the room, and enables the guest to enter the room. The invention allows personalized consideration from a preference database, so that a simple scan of a guest card at the automated check-in or by hotel personnel results in a number of personalized, preconditioning events happening without any other questions or interaction with any hotel personnel.

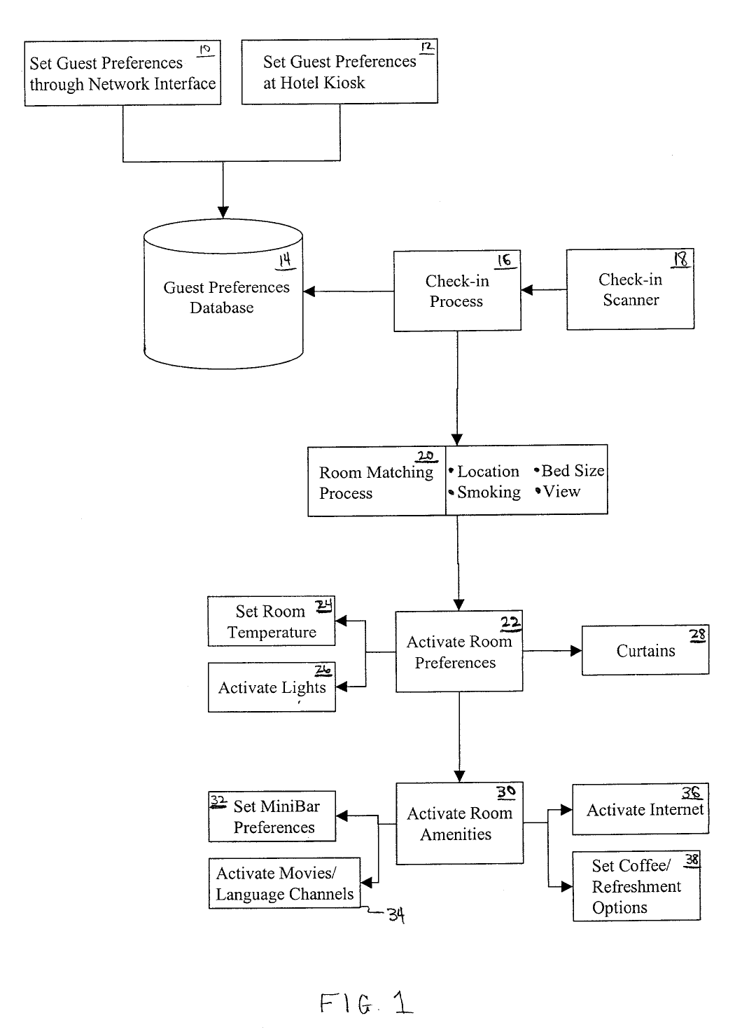

FIG. 1 is a block diagram illustrating an automated hotel room check-in and room personalization system. This system and method allow the user to define their reservation and environmental preferences in advance of their hotel visit. These preferences are entered into a database via an electronic network interface 10 which may be an Internet web site. Access to the preferences can be through a public web site that has a private area and graphical interface for reservation and environmental preferences collecting.

If the hotel guest cannot access a networked interface, they may also setup their reservation and environmental preferences at a computer kiosk 12 located in the hotel or through telephone operator access. A local kiosk in the hotel that is dedicated to setting preferences and customer service is beneficial because the hotel guest can make preference changes while they are in the hotel and thinking about their preferences. A kiosk in the hotel also allows users to view their room bill in real-time and the status of service requests. This type of system is valuable to business travelers who stay in hotel rooms often and desire to have certain room settings and amenities. In addition, the reservation and environmental preferences can be set by the travel agent who makes the hotel reservation for the hotel guest.

A preferences database 14 stores the hotel guest's reservation preferences and environmental preferences. This database is preferably a centralized database which is accessible by each hotel or frequently mirrored (i.e., duplicated) for each hotel. A central database is an effective configuration because it allows multiple hotels to contact the database for information. For example, a preferences database can be used for a single hotel chain or many hotel chains can access the preferences database. If many different hotel chains or separately owned corporations are accessing the database, then a third party administrator would control the access to the preferences database and control the information which could be retrieved or entered into that database. This way each hotel chain only has access to the preference features that apply to their specific chain. For example, there may be a set of common preferences that apply to all hotels such as temperature and lighting and then several other sub-sets of preferences which apply only to Hilton hotels or Marriott hotels, etc. Every hotel could download the common preferences and then their specific sub-set for that hotel group. Accordingly, the hotel may be charged a small access fee for downloading the customer's profile.

A centralized system allows hotel guests to store their reservation preferences and environmental preferences and then permit selective access to any hotel regardless of whether those hotels are commonly owned. Using a centralized database also permits the preferences to be stored for a longer period of time than a single hotel would normally store such preferences (e.g., a few years instead of a few months). Even independent hotels can access this centralized information if they have arranged for an account with the third party administrator. In some situations, when the hotel guest checks-in to a hotel without a reservation, the hotel guest's environmental preferences can immediately be retrieved from a central database and then applied to the room. This way all of the available preferences would be applied as completely as possible for that hotel. Of course, it should also be realized that the preferences can also be stored locally for each separate hotel and then implemented locally only.

The preferences database can also store hotel room availability and room configurations on behalf of actual hotels. Storing room configurations, such as bed sizes, room locations, or nonsmoking designations in the global database allows hotel guests to know which hotels can fulfill their pre-stored preferences. This provides a centralized clearing house for hotel room reservations that is driven by the reservation and environmental preferences. In this system, a reservation can also be confirmed and locked in by the hotel guest as soon as it is actually made with a centralized data storage type of system. Alternately, the room configuration information may be stored separately from the preferences database for fast data access by the check-in computer. This way room availability may be stored and processed locally.

Referring again to FIG. 1, a check-in card scanner 18 in the hotel scans a guest identification card and starts a check-in process 16 or check-in software application. The check-in process may retrieve the guest's reservation preference information from the preferences database 14 and locate the appropriate room. Then the system immediately applies the environmental preferences to the hotel room to prepare the room for the guest's arrival.

If the room selection and reservation have taken place in advance, then the environmental preferences can also be applied at a pre-set time. For example, if the hotel guest knows that their flight arrives at 4:00 P.M. then the room can have the environmental preferences concurrently applied and the room will be the correct temperature when they arrive.

As an alternative to direct card scanning for identifying a hotel guest, a proximity card can be automatically scanned as the guest enters the hotel. This allows the guest to be recognized without requiring a card to be removed from the guest's pocket or luggage. The preferences database information can also be stored on the proximity card and read as the guest enters the hotel. Storing and reading the preferences database from the proximity card may be faster than accessing a centralized database. Storing the database on the card does have the drawback that the guest must have the card for automated check-in.

With a centralized database, the hotel guest can enter a login, password, and account to begin the check-in process. Alternately, the guest can have the preferences database stored on their smart card which is scanned when they begin an automated check-in. If a proximity card is used or the customer checked in electronically from the airport in advance, a display screen may be located in the lobby which displays the room number where the guest will be staying. The hotel guest can also be positively identified through other means such as fingerprint scanning or a retinal scan which checks them into the hotel.

If the room has not been selected already, a room matching process 20 is initiated which electronically finds a room which most closely matches the hotel guest's preference information. The system uses all of the guest's reservation preferences and searches the available hotel rooms for the greatest match possibility. This match must be performed because certain elements of a room cannot be easily customized. For example, the location of the room, the room's bed size, whether it is a smoking or nonsmoking room, and the room view cannot be easily changed. Rooms which match the guest's reservation preferences must be selected out of the hotel's existing room inventory. As mentioned, the guest may be allowed to preselect the options for a physical room location such as a preferred floor, view, and relationship to elevators and exits. Hotel guests also may select a bed size, proximity to pool, restaurants, streets, etc.

After the appropriate room is selected, the room's door lock will be electronically set to match the guest's credit card or a special card dispensed for the continued use of the guest. Using this system can avoid the need to check-in at the front desk for a key or room number. Furthermore, the hotel can use a smart card or hotel club card as the check-in card which identifies the hotel guest. If a smart card is used, then it is easy to use the smart card as the hotel room door key. Scanning or identifying the hotel guest may then take place at the hotel room lock and the guest can enter the room, where they are automatically checked in all in one step. An alternate key arrangement is to have a key dispensed from an automated check-in kiosk. This dispensed key is then programmed as part of the automated check-in and is used by the hotel guest. A credit card can also be used as the hotel room key.

Since the room matching process 20 determines a room match, it is important that the guest outlines a number of room priorities for items that cannot be changed. If the guest has selected a king size bed as their first priority, they should also designate a second priority such as two twin beds. Similarly, if the guest has requested a room at a certain price level, they should also designate a secondary acceptable price range. This prioritization allows the system to more easily match the guest's criteria. If an appropriate match cannot be made, then the guest is referred to the hotel clerk.

After the reservation preferences have been matched, then the environmental preferences are activated 22 through an electronic network. The electronic network is configured to apply the environmental preferences which represent the alterable room options. The computer program sends messages to the electronic peripherals in the hotel room, and these messages can be sent via a physical wire network or wirelessly. The application of the environmental preferences can be initiated by the hotel guest's check-in, a timed event, a remote communication from the hotel guest (e.g., computer network or telephone), or activated by the hotel staff. Of course, the room selection may be done manually by a hotel clerk and then the environmental preferences can be remotely applied.

As part of the application of the environmental preferences, the room temperature is remotely set 24 to the temperature requested by the guest and the climate control system is activated so the room is the appropriate temperature when the guest enters. Then the lights are activated 26 by the network as requested by the hotel guest. The environmental preferences allow the user to define whether the lights will be on or off. If the guest desires a greater level of control, certain individual lights may be controlled such as the bathroom, vanity, or bedside lights. Another element which can be controlled by the hotel guest is whether the window coverings (e.g., curtains) are open or closed 28. A signal can be sent to either open or close the powered curtains or blinds. Other physical room options may also be set when the appropriate electronic peripheral hardware is installed in the hotel room. For example, a guest can control the heat of the bathroom water, whether the television is on or off, what time the coffee begins brewing, a time for refrigerator unit power down, etc.

When the basic environmental preferences are completed, then the product preferences 30 or room amenities can be applied. In other words, room conditions which do not affect the physical room environment may be set second. The guest can choose such amenities such as a minibar, a safe, or coffee type. Many hotels provide a complementary coffee package to their guests. The coffee provided to the guest can be configured using this system. The guest can select the coffee type they desire in advance 38. If they select the hotel's standard brand, they receive it free. If they pick a premium brand, they will pay the hotel an extra fee based on the brand picked. This is beneficial to the hotel because this generates a small revenue stream from the coffee, and the guest gets exactly the brand they want. These multiple brands of coffee can be stored in the minibar and then the brand that the guest picked is enabled based on their preferences and the other brands are locked. Alternately, a network enabled, tabletop vending device can be used which allows the guest to access only the brand they selected or purchased in their preferences.

Certain options in the minibar can be configured at check-in 32. The language preference for the minibar can be set, along with the preferred contents of the minibar. The dispensing of certain items may be disabled as preset by the guest (e.g., alcohol if minors will be staying in the room). If the guest makes minibar requests earlier in the day through the automated check-in system, hotel personnel can load those vending items into the minibar before the guest arrives. Depending on the selections available at the particular room selected for the guest at the time of reservation or check-in, a special alert will go to housekeeping and items such as coffee (for special brands) or special selections in the minibar. The guest can also make an advance request for ice which would activate an ice machine in the room if there is one. Other more general requests can be entered in a free form part of the environmental preferences questionnaire which is then forwarded to the desk clerks at check-in. The clerks would either fulfill those requests or call the guest to discuss the cost of obtaining certain items, etc.

A separate aspect of the product preferences is that product choices may also be available. Instead of an all or nothing type of choice, the hotel guest may be able to select the pillow that they want. For example, a soft, hard, or medium pillow. The guest could also select a thick or thin pillow. There may also be choices as to which brand shampoo like or what type of towel they would like.

Another important set of preferences is the data preferences. These data preferences allow the guest to select whether they activate the Internet connection provided to their room 36. It also allows them to activate certain premium movie channels or adult movies that the hotel offers 34. Likewise, the data preferences can set the language of the television channels or movies. There are options for the type of newspaper the guest would like to have delivered to their room in the morning. An additional option allows the hotel guest to select one of a few popular magazines to be delivered to their room. Video games may also be enabled through the television or a network enabled game console based on the data preferences. If the user selects the game option in the data preferences, then the gaming device is enabled before the hotel guest enters the room.

Further data preferences are for voice mail and a computer generated wake up call. As part of the application of the data preferences, the system automatically sets up an account folio. The voice mail of the phone system is preset to a computer generated pronunciation of the guest's name unless they set it to a personalized voice message. The data preferences can also be set to audibly notify the guest of voice messages when the room is entered.

Many hotel rooms contain either an empty refrigeration unit for guest use or a refrigeration unit that contains vending items. Another environmental preference that a guest can control is the noise factor of the refrigeration unit in their room. A compressor is used in the cooling system of the refrigerator and the noise produced by the compressor can be irritating to a guest. This is particularly true if the compressor runs as the guest is trying to go to sleep. Refrigeration units can be configured to include a cooling system with computerized logic that controls the refrigeration unit temperature and when the cooling system is activated. This way the cooling system can be de-activated while the hotel guest is asleep or during some selected time period. The current invention allows the hotel guest to electronically pre-set when the refrigerator will run. For example, the guest can electronically select the option that the refrigeration unit should be “night quiet”. This option is then remotely applied when the guest will be staying in the room.

After the guest is in the room, a software program controls the room as specified in the environmental preferences. Motion sensors connected to the climate control in the room monitor when the guest is awake or asleep. This allows the climate control to set the lighting and temperature when the guest is gone, and the system provides and maintains the most economical power settings. For example, the room can be set to turn off the air conditioning when the guest leaves the room for a certain period of time. Then the system automatically returns the room to the guest's preferred temperature when the guest reinserts his card/key. If a proximity card or key is used then the climate control system can be activated when the guest enters or leaves a hotel doorway. This control method is also applicable to the heating system.

The advantage of this new technology is that the guest can use an identification card or a password code in a check-in terminal and then a computer program makes decisions based on the information in the hotel guest's reservation and environmental preferences. An automated check-in saves the hotel money because it requires fewer hotel clerks. Guests save time because they do not need to wait in a long check-in or check-out lineup. This system can even be configured to allow guests to check-in via a remote networked terminal at the airport or via the Internet. This way they are assigned a room number and can then proceed directly to their room upon arrival at the hotel.

Of course some hotels may still want to include the personalized human touch to their check-in. This can be accomplished by having the hotel guest scan their smart card or credit card first. A computer performs the necessary room selections and setting of the environmental preferences. Next, the guest interacts briefly with the hotel clerk who greets them and gives them a general information package and receipt.

When the guest leaves the room for checkout, the guest simply scans their card at the hotel exit. The reader alerts the guest if there was anything left in the safe or provides any other special messages. A final financial folio is then printed or posted to a message screen which the guest may access at any time during the next 90 days for printing or resolving bill discrepancies. An electronic bill provides an easily accessible receipt and record of the charges.

After checkout, the room automatically returns to a standard setting or a quiet mode upon the guests' checkout. As another option, the room can be returned to the standard setting at the time of normal checkout, or at a time preset by hotel housekeeping.

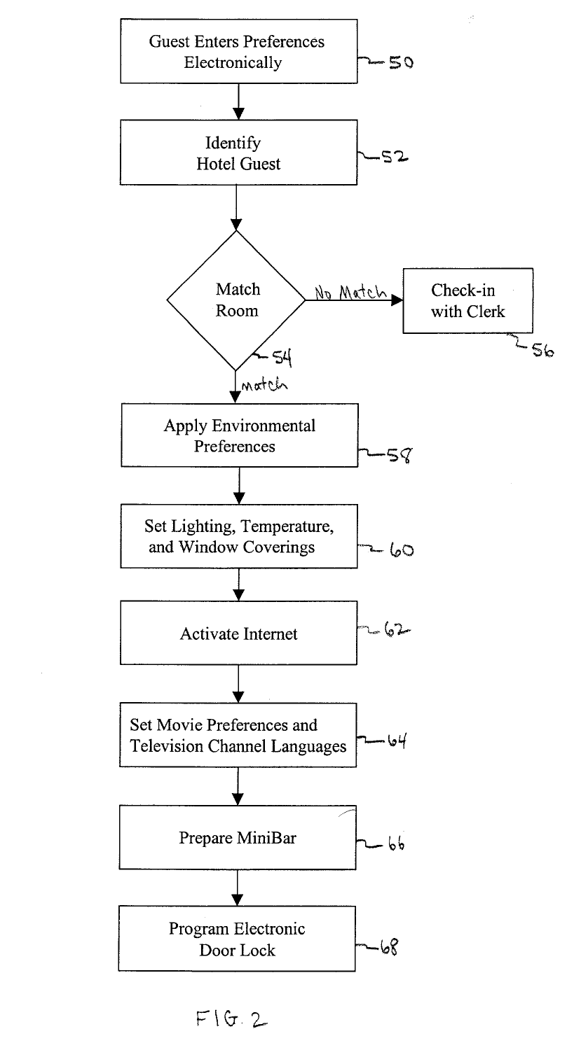

A detailed method for the present device will now be discussed. FIG. 2 is a flow chart illustrating the method for automatically and electronically personalizing a hotel room. The first step is storing personalized reservation and environmental preferences prior to a hotel visit. The guest enters their preferences electronically through a web site or a software application connected to a database 50. Then the hotel guest is identified upon entering the hotel, which initiates room check-in and the retrieval of the environmental preference information. Hotel guests can be identified by a scanner 52 using a direct card scanner, a proximity card, or some other identification method. A software process then finds a room which most closely matches the hotel guest's reservation preferences 54. The match is based on room attributes which are not configurable such as the bed size, room location or smoking/nonsmoking. If no suitable room is found, then the guest is referred to check-in with the clerk 56.

After a matching room is selected, the system begins electronically setting applying the environmental preferences 58. This includes setting the lighting, room temperature and window coverings to the guest's predefined preferences 60. A connection to the Internet can also be activated 62 if the guest has set that option and has agreed to the associated cost. The guest's preferences also control the language of the television, cable and movie channels, and which premium movie channels will be paid for and viewed 62. The minibar is also set to the appropriate language and certain items are enabled or disabled based on the guest's preferences 66. The room's electronic door lock is also programmed to accept a key, key card or credit card the hotel guest will be using 68. Although the implementation of this invention has been described as being used primarily in a hotel, it should be clear that an automated check-in and room preferences setting system can also be applied in other similar “lodging” situations. For example, this system is useful for cruise ships, timeshare condominiums, tanning salons, or other time appropriated rooms.

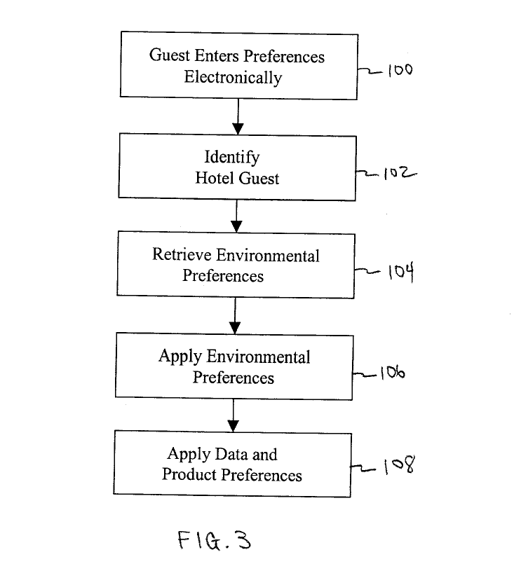

FIG. 3 illustrates another preferred method for the present invention. In order for a prospective hotel guest to use the hotel room preferences system, the guest must first enter their reservation preferences and environmental preferences into the system 100. These preferences are entered electronically through a web page or telecommunications link. Then the preferences are stored in a database prior to a hotel visit. These preferences may be stored in a relational database, a flat file database, or even in computer memory. Optionally, the hotel guest is identified 102. Next, the environmental preferences for a specifically identified hotel guest are retrieved from the database 104. Following the retrieval step, the environmental preferences are applied to the hotel room in preparation for a guest's arrival 106. The environmental preferences can be applied based on the identified hotel guest or based on the hotel room a guest already reserved. Environmental preferences will be applied in detail as described previously. As a part of applying the environmental preferences, at least two subclasses of the environmental preferences can be applied. The first subclass is data preferences which control the information, entertainment, telecommunications, and languages provided to the hotel guest 108. The second subclass is product preferences which govern the types of products available or delivered to the hotel guest. It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method for electronically personalizing and preconditioning a hotel room for a hotel guest, comprising the steps of:
(a) identifying adjustable in-room conditions as environmental preferences;
(b) entering and storing the environmental preferences of a guest in an accessible electronic database in connection with the hotel visit;
(c) retrieving the hotel guest's environmental preferences; and
(d) applying the environmental preferences to adjust the in-room conditions in preparation for the guest's visit.

2. A method as in claim 1, wherein step (d) further comprises the step of applying the environmental preferences remotely via an electronic network.

3. A method as in claim 1, wherein step (d) further comprises the step of applying the environmental preferences at a pre-selected time associated with an arrival date for the guest.

4. A method as in claim 1, wherein step (d) further comprises the step of applying the environmental preferences at hotel guest check-in time.

5. A method as in claim 4, further comprising the step of identifying a guest by directly scanning an identification card to initiate check-in and retrieval of hotel guest's environmental preferences.

6. A method as in claim 4, further comprising the step of identifying a guest by scanning a proximity card to initiate room check-in and retrieval of the hotel guest's environmental preferences.

7. A method as in claim 1, further comprising the step of electronically pre-adjusting the room temperature to a temperature defined in the hotel guest's environmental preferences prior to the arrival of the guest.

8. A method as in claim 1, further comprising the step of electronically setting in-room lighting conditions based on the lighting conditions defined in the hotel guest's environmental preferences.

9. A method as in claim 1, further comprising the step of setting a room lock electronically at check-in to match the hotel guest's electronically readable key.

10. A method as in claim 1. wherein step (b) further comprises the step of storing the hotel guest's environmental preferences prior to a hotel visit by storing information on the hotel guest's identification card.

11. A method as in claim 1, wherein step (b) further comprises the step of storing the hotel guest's environmental preferences prior to a hotel visit by storing information in a database remote from a hotel.

12. A method for automatically and electronically preconditioning a hotel room for a specific hotel guest, comprising the steps of:
(a) identifying adjustable in-room conditions as environmental preferences;
(b) storing the hotel guest's environmental preferences and reservation preferences in a database prior to a hotel visit;
(c) identifying the specific hotel guest in connection with the hotel visit to initiate the retrieval of the environmental and reservation preferences;
(d) selecting a room based on the reservation preferences; and
(e) applying the environmental preferences to the hotel room.

13. A method as in claim 12, further comprising the step of setting hotel guest information delivery and language options, based on a hotel guest's data preferences.

14. A method as in claim 12, further comprising the step of enabling delivery of movies based on selections in a hotel guest's data preferences.

15. A method as in claim 12, further comprising the step of enabling coffee delivery to a guest through an automated, remotely configurable in-room coffee dispenser.

16. A method as in claim 13, further comprising the step of enabling an in-room Internet connection based on the hotel guest's data preferences.

17. A method for automatically and electronically preconditioning a hotel room for a specific guest, comprising the steps of:
(a) identifying adjustable in-room conditions as environmental preferences;
(b) storing hotel guest environmental preferences in a database for a hotel visit;
(c) identifying the specific guest at check-in time;
(d) retrieving the hotel guest environmental preferences for the specific guest; and
(e) setting room options via networked electronic peripherals located in the room, wherein the room option settings match the hotel guest environmental preferences.

18. An automated hotel room check-in and preference setting system, comprising:
(a) a data storage system;
(b) a data file stored in the data storage system, including the preferences of a specific guest;
(c) an electronic user interface, coupled to the data storage system, to allow a hotel guest's environmental preferences to be entered;
(d) an identification means for identifying a guest and initiating the retrieval of reservation and environmental preferences from the database; and
(e) an electronic network, coupled between the database and the plurality of rooms, configured to prepare a hotel room as specified by the environmental preferences.

19. A method as in claim 18, wherein the electronic network is configured to apply environmental preferences to electronically enabled devices in the hotel room.

20. A method for automatic hotel room configuration and room selection, comprising the steps of:
(a) identifying adjustable in-room conditions as environmental preferences;
(b) storing a hotel guest's reservation preferences and environmental preferences prior to a hotel visit;
(c) selecting a room based on the reservation preferences;
(d) preconditioning the room according to the environmental preferences; and
(e) providing the guest with electronic key access, wherein a room lock is remotely programmed as part of the room preconditioning to match an electronic key to be provided for the guest.

21. A method as in claim 20, wherein the step of preparing the room further comprises the step of identifying a guest via an electronic scanner to initiate the room preparation.

22. A method as in claim 20, wherein the step of preparing the room further comprises the step of preparing the room based on the environmental preferences at a pre-set time relative to entry of the guest into the room.

23. A method for automated check-in prior to arrival of a guest at a hotel, comprising:
(a) identifying preferences in accordance with in-room conditions;
(b) enabling activation of the preferences prior to arrival of a guest; and
(c) adjusting in-room conditions to a pre-set format prior to guest arrival.
